(19) United States
(12) Patent Application Publication
(10) Pub. No.: US 2025/0159769 A1
(43) Pub. Date: May 15, 2025

(54) MICROWAVE APPLIANCES AND PROTECTIVE DOOR FEATURES

(71) Applicant: Haier US Appliance Solutions, Inc., Wilmington, DE (US)

(72) Inventors: John Michael Todd, Mount Washington, KY (US); Zachary Cull, Louisville, KY (US); Chau Tran, Louisville, KY (US)

(21) Appl. No.: 18/507,619

(22) Filed: Nov. 13, 2023

(51) Int. Cl. H05B 6/64; H05B 6/66

(52) U.S. Cl. CPC H05B 6/6417; H05B 6/666

(57) ABSTRACT

A microwave oven appliance may include a cabinet, a magnetron, a control panel, a chamber door, a primary door input, a secondary unlock input, and a controller. The chamber door may be movably mounted to the cabinet to selectively restrict access to a cooking chamber in a closed position. The primary door input may be to release the chamber door from the closed position. The secondary unlock input may be to selectively direct the chamber door to an unlocked state. The controller may be configured to direct a door-monitoring operation that includes initiating a lock condition according to a predetermined time period for which the chamber door is to require multi-step opening procedures, determining a cleared-chamber state, and initiating an unlock condition in which the lock condition is halted and the chamber door is held in an unlocked state permitting single-step opening procedures at the primary door input.

### FIELD OF THE DISCLOSURE

The present subject matter relates generally to microwave appliances, and more particularly to features and methods for protecting doors thereof.

### BACKGROUND OF THE DISCLOSURE

Microwave oven appliances generally include a cabinet that defines a cooking chamber. The cooking chamber may receive food items for cooking. A door may be pivotally mounted to the cabinet to provide access to the cooking chamber. Microwave oven appliances generally heat food by activating an energy source, such as a magnetron, to generate cooking energy or microwaves. In order to contain the radioactive energy waves, microwave oven appliances generally have a door latch mechanism to latch the door in a closed position during cooking. Furthermore, an indication to a controller that the door is closed is typically provided to ensure that the microwave oven appliance may be operated safely.

In addition to these safeguards while the microwave oven is on, inadvertent opening of a microwave door may also be undesirable. For example, food or items inside a microwave may have an increased temperature following cooking, and inadvertent opening of the microwave door to get food or items out of the microwave oven appliance may be expose a user (e.g., young users) to hot items before they are ready to be handled. In order to address such concerns, recently proposed regulations or standards may mandate two-step opening procedures or systems for opening the chamber doors of various microwave appliances under certain conditions.

Although additional standards and systems may enhance safety under certain conditions, challenges may also arise. In particular, it may be difficult to inform and educate users about the additional standards or systems. As a result, there is potential for users to ignore the new procedures for opening the chamber door. It may be especially bothersome or confusing for users if such standards or systems are applied to conditions in which nothing is left within the cooking chamber or a user has already taken appropriate precautions. In some cases, confusion may even cause a user to inadvertently damage the door or various other components of a microwave appliance.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a microwave oven appliance is provided. The microwave oven appliance may include a cabinet, a magnetron, a control panel, a chamber door, a primary door input, a secondary unlock input, and a controller. The cabinet may define a cooking chamber. The magnetron may be mounted within the cabinet in communication with the cooking chamber to direct a microwave thereto. The control panel may be mounted to the cabinet. The chamber door may be movably mounted to the cabinet to selectively restrict access to the cooking chamber in a closed position. The primary door input may be attached to the cabinet in operable communication with the chamber door to release the chamber door from the closed position. The secondary unlock input may be attached to the cabinet to selectively direct the chamber door to an unlocked state. The controller may be in operable communication with the control panel. The controller may be configured to direct a door-monitoring operation that includes initiating a lock condition in which the chamber door is directed to a locked state according to a predetermined time period for which the chamber door is to require multi-step opening procedures, determining, prior to expiration of the predetermined time period, a cleared-chamber state, determining the cleared-chamber state including receiving a cleared-chamber signal, and initiating, prior to expiration of the predetermined time period and in response to determining the cleared-chamber state, an unlock condition in which the lock condition is halted and the chamber door is held in an unlocked state permitting single-step opening procedures at the primary door input.

In another exemplary aspect of the present disclosure, a method of operating a microwave oven appliance is provided. The method may include initiating a lock condition in which the chamber door is directed to a locked state according to a predetermined time period for which the chamber door is to require multi-step opening procedures. The method may also include determining, prior to expiration of the predetermined time period, a cleared-chamber state. Determining the cleared-chamber state may include receiving a cleared-chamber signal. The method may further include initiating, prior to expiration of the predetermined time period and in response to determining the cleared-chamber state, an unlock condition in which the lock condition is halted and the chamber door is held in an unlocked state permitting single-step opening procedures at a primary door input.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a microwave oven according to exemplary embodiments of the present disclosure.

FIG. 2 provides an elevation view of a microwave oven according to exemplary embodiments of the present disclosure, wherein the door in a closed position.

FIG. 3 provides a perspective view of the exemplary microwave oven appliance of FIG. 2, wherein the door is in an open position.

FIG. 4 provides a sectional elevation view of a door release assembly according to exemplary embodiments of the present disclosure.

FIGS. 5A, 5B, 5C provide sectional elevation views illustrating movement of a door release assembly between an extended position and a retracted position according to exemplary embodiments of the present disclosure.

FIG. 6 provides a perspective view of a microwave oven according to exemplary embodiments of the present disclosure.

FIG. 7 provides an elevation view of a microwave oven according to exemplary embodiments of the present disclosure.

FIG. 8 provides a flow chart illustrating a method of operating a microwave oven appliance according to exemplary embodiments of the present disclosure.

FIG. 9 provides a flow chart illustrating a method of operating a microwave oven appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents. The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Generally, it may be useful to limit access to a cooking chamber of a microwave oven appliance only under certain conditions. Additionally or alternatively, a microwave or method that prevents confusing or unhelpful application of safety related features for opening of a microwave oven appliance door would be beneficial (e.g., without risking damage to the door or an opening mechanism).

The present disclosure advantageously provides a microwave appliance that can facilitate selective requirements of multi-step opening of a door of the microwave appliance (e.g., in accordance with standards, such as UL 923 7^{th} Edition). The appliance may include features for determining if appropriate consideration of various dangers has been taken or would be useful in the current state of the microwave appliance. This may advantageously prevent a user from inadvertently damaging the appliance or minimize frustrations to a user.

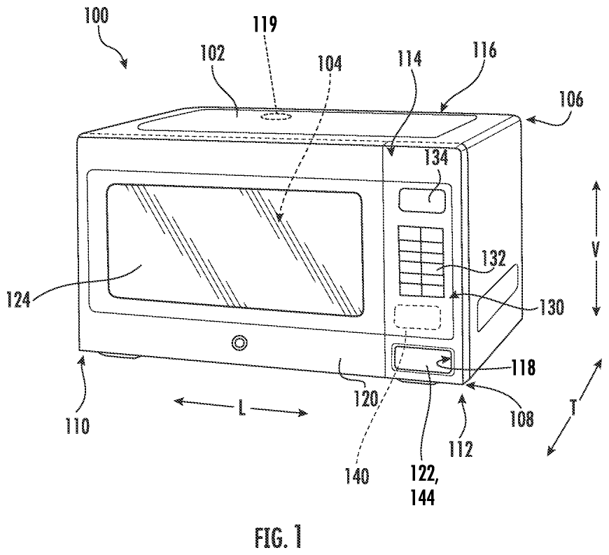

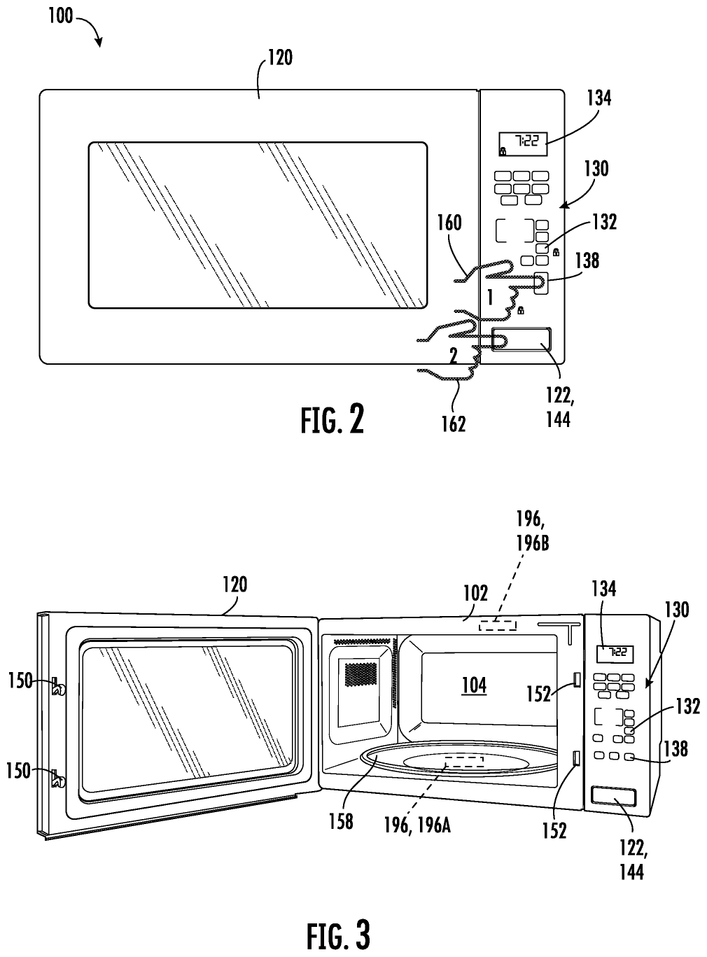

Turning now to the figures, FIG. 1 provides a front, perspective view of a microwave oven appliance (i.e., microwave or microwave oven) 100 as may be employed with the present disclosure. FIG. 2 provides an elevation view of microwave appliance oven appliance 100 with a chamber door in a closed position. FIG. 3 provides a front, perspective view of a microwave oven 100 with the door in an open position.

Microwave oven 100 generally includes an insulated cabinet 102. Cabinet 102 defines a cooking chamber 104 for receipt of food items for cooking. As will be understood by those skilled in the art, microwave oven 100 is provided by way of example only, and the present subject matter may be used in any suitable microwave oven, such as a countertop microwave oven, an over-the-range microwave oven, etc. Thus, the example embodiments detailed herein are not intended to limit the present subject matter to any particular cooking chamber configuration or arrangement.

As illustrated, microwave oven 100 generally defines a vertical direction V, a lateral direction L, and a transverse direction T, each of which is mutually perpendicular, such that an orthogonal coordinate system is generally defined. Cabinet 102 of microwave oven 100 extends between a top 106 and a bottom 108 along the vertical direction V, between a first side 110 (left side when viewed from front) and a second side 112 (right side when viewed from front) along the lateral direction L, and between a front 114 and a rear 116 along the transverse direction T.

Microwave oven 100 includes a chamber door 120 that is pivotably or rotatably attached to cabinet 102 in order to permit selective access to cooking chamber 104. As will be described in greater detail below, a separate primary door input 122 and secondary unlock input 138 are generally provided for releasing and opening the chamber door 120. The separate primary door input 122 and secondary unlock input 138 may be engaged, such as in a prescribed order for a multi-step opening procedure wherein the secondary unlock input 138 is first engaged (e.g., as indicated by hand “1” for a first user engagement action 160) and the primary door input is next engaged (e.g., as indicated by hand “2” for a second user engagement action 162). The primary door input 122 may include a door release button (e.g., slidable button 144) that selectively allows entry into cooking chamber 104 (e.g., in response to engagement or pressing of the door release button 144). In some embodiments, a handle 156 is mounted to door 120 to assist a user with opening and closing door 120 in order to access cooking chamber 104. As an example, a user can pull on the handle 156 mounted to door 120 to assist in opening or closing door 120 to access cooking chamber 104. In some embodiments, a latch or equivalent mechanism may be used to engage door 120, maintaining door 120 in a closed position until door 120 is motivated or released by primary door input 122, as will be discussed in more detail below. Glass window panes 124 may provide for viewing the contents of cooking chamber 104 when door 120 is closed and also assist with insulating cooking chamber 104.

In some embodiments, front 114 defines a body cavity 118. Body cavity 118 may be defined through front 114 and into cabinet 102 in transverse direction T. Body cavity 118 may receive a primary body of button 144.

Microwave oven 100 is generally configured to heat articles (e.g., food or beverages, within cooking chamber 104 using electromagnetic radiation) during or as part of a heating cycle. Microwave appliance 100 may include one or more heating elements 119, such as components that operate (e.g., when activated) to produce the electromagnetic radiation, as is generally understood. For example, microwave appliance 100 may include a magnetron heating element 119 (such as, for example, a cavity magnetron), a high voltage transformer, a high voltage capacitor and a high voltage diode. When activated, the transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to cooking chamber 104.

The structure and intended function of microwave ovens are generally understood by those of ordinary skill in the art and are not described in further detail herein. According to alternative embodiments, microwave oven may include one or more heating elements, such as electric resistance heating elements, induction heating elements, other microwave heating elements, halogen heating elements, or suitable combinations thereof, are positioned within cooking chamber 104 for heating cooking chamber 104 and food items positioned therein.

As shown, a control or user interface panel 130 and a user input device 132 may be positioned on an exterior of the cabinet 102 (e.g., for selecting one or more heating cycles or variables for the same, as is understood). The user interface panel 130 may represent a general purpose Input/Output (“GPIO”) device or functional block. In some embodiments, the user interface panel 130 may include or be in operative communication with user input device 132, such as one or more of a variety of digital, analog, electrical, mechanical, or electro-mechanical input devices including rotary dials, control knobs, push buttons, and touch pads. The user input device 132 is generally positioned proximate to the user interface panel 130, and in some embodiments, the user input device 132 may be positioned on the user interface panel 130. The user interface panel 130 may include a feedback component 134, which may include or be provided as a digital or analog display device designed to provide visual operational feedback to a user (e.g., as would be understood). Separate from or in addition to the display device, the feedback component 134 may include or be provided as a speaker device designed to provide audible or auditory feedback from generated soundwaves (e.g., as would be understood). Additionally or alternatively, the feedback component 134 may include or be provided as a haptic device designed to provide tactile feedback from generated vibrations conveyed to a user in contact with the interface panel 130 (e.g., as would be understood).

With or separate from the control or user interface panel 130, microwave oven 100 may provide a plurality of multi-step inputs for opening or otherwise releasing chamber door 120 from the closed position (e.g., under certain or selective lock conditions). In some embodiments, the multi-step inputs include a separate primary door input 122 and a secondary unlock input 138, each attached to the cabinet 102 (e.g., directly or indirectly). Separate engagement of the primary door input 122 and secondary unlock input 138 may serve to release the chamber door 120 (e.g., under one or more predetermined conditions), as will be described in greater detail below. In particular, the secondary unlock input 138 may be provided (e.g., in operable communication with a door lock 154 or controller 140) to selectively direct the chamber door 120 to an unlocked state when under a lock condition. The primary door input 122 may be provided (e.g., in operable communication with the chamber door 120) to release the chamber door 120 from the closed position, such as when the chamber door 120 has first been placed in the unlocked state (e.g., temporarily or under an unlock condition.

Generally, microwave oven 100 may include a controller 140 in operative communication with the user input device 132 (e.g., separate from or in addition to the primary door input 122 or secondary unlock input 138). The user interface panel 130 of the microwave oven 100 may be in communication with the controller 140 via, for example, one or more signal lines or shared communication busses, and signals generated in controller 140 operate microwave oven 100 in response to user input via the user input devices 132. Input/Output (“I/O”) signals may be routed between controller 140 and various operational components of microwave oven 100. Operation of microwave oven 100 can be regulated by the controller 140 that is operatively coupled to the user interface panel 130.

Controller 140 is a “processing device” or “controller” and may be embodied as described herein. Controller 140 may include a memory and one or more microprocessors, microcontrollers, application-specific integrated circuits (ASICS), CPUs or the like, such as general or special purpose microprocessors operable to execute programming instructions or micro-control code associated with operation of microwave oven 100 (e.g., method 800 or 900), and controller 140 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, a controller 140 may be constructed without using a microprocessor (e.g., using a combination of discrete analog and/or digital logic circuitry—such as switches, amplifiers, integrators, comparators, flip-flops, AND gates, and the like—to perform control functionality instead of relying upon software).

In optional embodiments, a presence detection sensor (PDS) 196 is mounted within the cooking chamber 104. Specifically, PDS 196 may be mounted on or within cabinet 102, such as to communicate with at least a portion of cooking appliance 100 within cooking chamber 104 (e.g., at a rotatable platter or support pan 158 or other food-receiving portion of the appliance 100). PDS 196 may be in operable (e.g., wired or wireless) communication with controller 140 and configured to detect one or more items (e.g., a food item) on the support pan 158. For instance, PDS 196 may be configured to detect if or when a food item is present on support pan 158 and transmit one or more detection signals corresponding to the same.

In certain embodiments, PDS 196 is in mechanical communication with support pan 158. For instance, PDS 196 may be mounted below support pan 158 (e.g., on a bottom wall or platter). Movement or force of support pan 158 (e.g., as provided by a food item) may thus be transferred, at least in part, to PDS 196. In certain embodiments, PDS 196 includes a force sensor 196A, which is configured to receive a load thereon (e.g., a force, moment, or pressure load as generated by the presence of a food item on support pan 158). Any suitable force sensor 196A may be provided for PDS 196. For instance, the force sensor 196A may include or be provided as a weight/mass sensor (e.g., configured to detect a weight or mass value corresponding to a food item on support pan 158), pressure sensor (e.g., configured to detect a pressure value corresponding to pressure generated by the presence of a food item on support pan 158), or presence switch (e.g., reed switch, magneto resistive switch, push switch, or pressure switch configured to detect deflection above a set threshold as might be caused by the presence of a food item on support pan 158). Thus, the detection signals may include or correspond to a force signal received from force sensor 196A.

In additional or alternative embodiments, PDS 196 is provided as an optical sensor 196B. As illustrated, the optical sensor 196B may be spaced apart from support pan 158. For instance, the optical sensor 196B may be mounted in a top wall of shell (i.e., above support pan 158). Movement or objects (e.g., a food item) on support pan 158 may thus be sensed at the optical sensor 196B. Any suitable optical sensor 196B may be provided for PDS 196. As an example, the optical sensor 196B may include or be provided as a camera (e.g., video camera or a digital camera) having an electronic image sensor [e.g., a charge coupled device (CCD) or a CMOS sensor] configured to capture one or more images of support pan. As an additional or alternative example, the optical sensor may include or be provided as a break beam sensor configured to direct an optical beam (e.g., laser beam or infrared beam) at support pan, which may be interrupted by a food item and thus detected at the break beam sensor, as would be understood. Thus, the detection signals may include or correspond to an optical (e.g., image or break-beam) signal received from optical sensor 196B.

Although a particular force sensor 196A and optical sensor 196B are described above, it is noted that PDS 196 may include or be provided as an suitable sensor assembly configured to detect a food item within the cooking chamber 104 (e.g., directly or indirectly), as would be understood in light of the present disclosure.

Turning further to FIGS. 2 through 4, FIG. 4 provides a sectional elevation view of an exemplary a door release assembly 142 of a microwave oven 100 to facilitate opening the chamber door 120 (e.g., moving the chamber door 120 from a closed position—FIG. 2—to an on open or otherwise non-closed position—FIG. 3). It is noted that the door release assembly 142 illustrated is merely an exemplary embodiment and, except as otherwise explicitly claimed, is not intended to limit the present disclosure to any particular mechanism. Thus, and in light of the present disclosure, one of ordinary skill would understand that any suitable embodiment for opening or releasing chamber door 120 is within the scope of the present subject matter.

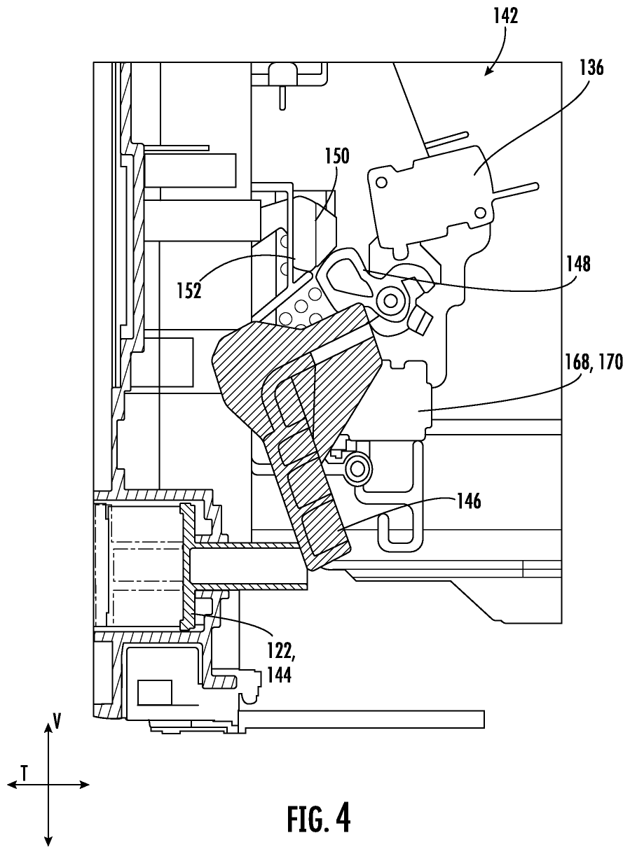

As noted above a primary door input 122 may be provided in operable (e.g., mechanical or electronic) communication with the chamber door 120, such as directly or through one or more intermediate components. In some embodiments, the primary door input 122 is provided as a slidable button 144 (e.g., as illustrated). Thus the primary door input 122 may be movable (e.g., to translate or pivot) relative to the cabinet 102. In some such embodiments, the slidable button 144 is movable between an extended position (e.g., as indicated in phantom lines at FIG. 4) and a retracted position (e.g., as indicated in solid lines at FIG. 4). As illustrated, the retracted position may provide the slidable button 144 in a relatively inward location within the cabinet 102 in comparison to the extended position. Additionally or alternatively, the retracted position may be configured to prompt movement of the chamber door 120 from the closed position, as would be understood in light of the present disclosure.

In certain embodiments, the primary door input 122 may be in mechanical communication with the chamber door 120 such that movement of the primary door input 122 is translated to the chamber door 120 (e.g., via one or more intermediate release mechanisms or drive train members). In the illustrated embodiments, the primary door input 122 is aligned with a first lever 146. Specifically, a rear portion of the slidable button 144 is in selective engagement with the first lever 146 to drive rotation of the same (e.g., as the slidable button 144 moves from the extended position to the retracted position). The illustrated first lever 146 is further in selective engagement with a second lever or gear 148, which itself is in selective engagement with one or more movable latches 150 (e.g., mounted on the chamber door 120 to hook against one or more corresponding catches 152 that are fixed to the cabinet 102) in the closed position of the chamber door 120. In turn, rotation of the first lever 146 may prompt rotation of the second lever 148, which in turn motivates movement (e.g., vertical translation) of a movable latch 150. Such movement of a movable latch 150 may serve to, for instance, lift the movable latch 150 from a corresponding catch 152, thereby releasing the chamber door 120 such that movement (e.g., pivoting) of the chamber door 120 from the closed position is permitted.

As shown, a door sensor 136 may be provided in selective communication with the door 120 (e.g., mechanical communication directly or, alternatively, indirectly-such as through second lever 148, as shown). Generally, door sensor 136 may operate to sense a position of door 120 (e.g., a closed position or an open position). For instance, door sensor 136 may be configured to detect if or when door 120 is in a closed position. Generally, door sensor 136 may include or be provided as any suitable sensor, such as a contact sensor, a reed switch, a Hall effect sensor, an optic sensor, or the like. For instance, as shown (e.g., in FIG. 3), door sensor 136 may be disposed proximate to second lever 148 to engage the same when second lever 148 is forced or rotated downward by the engaged movable latch 150. Optionally, door sensor 136 may be included with or as a part of a latch assembly configured to lock or otherwise hold the door 120 in the closed position, as would be understood in light of the present disclosure.

It is noted that although a slidable button 144 is illustrated, inter alia, in FIG. 4, any other suitable primary door input 122 may be provided. For instance, turning briefly to FIG. 7, primary door input 122 may be provided as a pull handle 156. As is understood, such embodiments may permit release of the chamber door 120 via the pulling motion provided by a user on the pull handle 156. As an example, the pulling motion may serve to simultaneously draw a movable biased latch to translate upwards over a corresponding static catch while the chamber door 120 moves (e.g., pivots) rearward away from the cabinet 102.

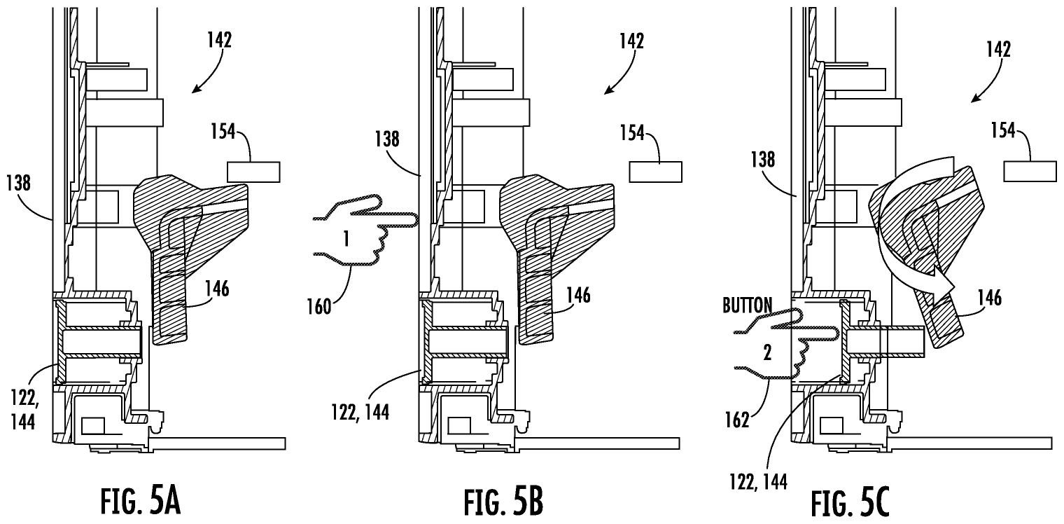

Turning now to FIGS. 5A, 5B, and 5C, various views sectional elevation views illustrating movement of a door release assembly 142 between an extended position and a retracted position. As noted above, a secondary unlock input 138 may be attached to the cabinet 102 separate from or in addition to primary door input 122. In some embodiments, the primary door input 122 is provided as an electronic button (e.g., one of user inputs 132, as illustrated and as are generally understood). The secondary unlock input 138 may be, for instance, in electrical communication with the controller 140 or a door lock 154. Thus, user engagement with the secondary unlock input 138 may prompt transmission of a corresponding signal to controller 140 or door lock 154.

Generally, the secondary unlock input 138 may be provided to direct the chamber door 120 to an unlock state in which release of the chamber door 120 is permitted (e.g., for a set temporary period of time or an indefinite time period, which may be contingent on a non-time-related action). In particular, the secondary unlock input 138 may be provided to facilitate a multi-step opening procedure from the chamber door 120. Thus, user engagement of the secondary unlock input 138 may be required to be separate or distinct from user engagement of the primary door input 122. Specifically, in order to open the chamber door 120 under certain conditions (e.g., a lock condition), a user may be forced to follow a set procedure in which a user is required to provide a first user engagement action 160 at the secondary unlock input 138 (e.g., to release the chamber door 120 to the unlocked state from a locked state) before then providing a second user engagement action 162 at the primary door input 122 (e.g., to move the chamber door 120 from the closed position, such as to an open position).

In some embodiments, secondary unlock input 138 is provided in operable communication with a dedicated door lock 154 (e.g., directly or, alternatively, indirectly such as via controller 140). In the illustrated embodiments, the door lock 154 is movably disposed in interference engagement with the first lever 146. Specifically, the door lock 154 is movable (e.g., as directed by the controller 140 and a solenoid motor—not pictured—corresponding to the door lock 154) between a locked state (FIG. 5A) and an unlocked state (FIGS. 5B and 5C). As shown, in the locked state, the door lock 154 may prevent full actuation or movement of the first lever 146 or primary door input 122 generally. By contrast, in the unlocked state, the door lock 154 may be separated from the path of the first lever 146 or drive train connected to the primary door input 122. As described above, engagement with the secondary unlock input 138 in the form of the first user engagement action 160 may place the door release assembly 142 in the unlocked state, such as by moving the door lock 154 to the unlocked state. Subsequently, engagement with the primary door input 122 in the form of the second user engagement action 162 may drive (e.g., the first lever 146 and) chamber door 120 from the closed position.

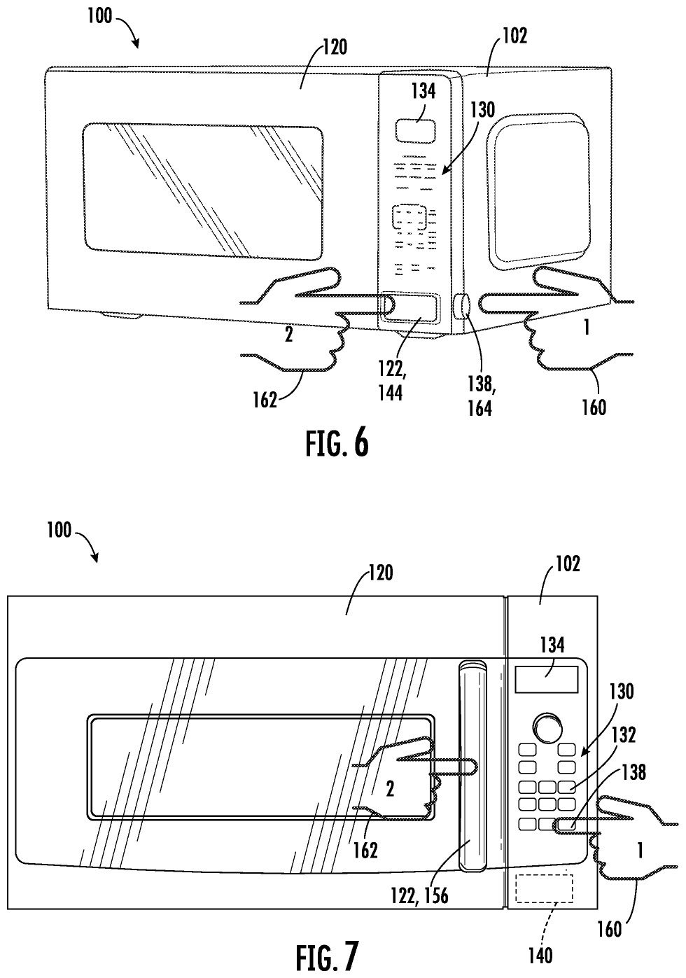

It is noted that although an electronic button is illustrated for secondary unlock input 138, inter alia, in FIG. 4, any other suitable secondary unlock input 138 may be provided. For instance, turning briefly to FIG. 6, secondary unlock input 138 may be provided as a mechanical button or input 164 (e.g., separate from user inputs 132 or in mechanical communication with door lock 154). As is understood, such embodiments may permit unlocking the chamber door 120 (e.g., without involving controller 140 or direct electrical communication in order to unlock the chamber 120). As an example, pushing the mechanical button 164 may forcibly move the internal lock (e.g., FIGS. 5A, 5B, 5C) from the locked state to the unlocked state. As would be understood a dedicated engagement switch or sensor may be provided in operable communication with the secondary unlock input 138 (e.g., to detect engagement of the same).

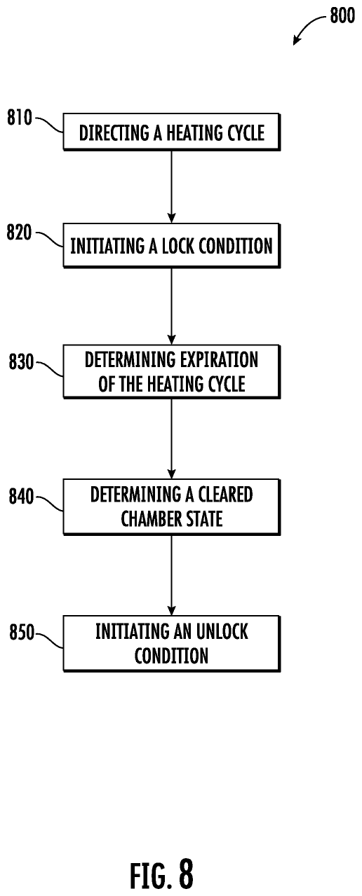

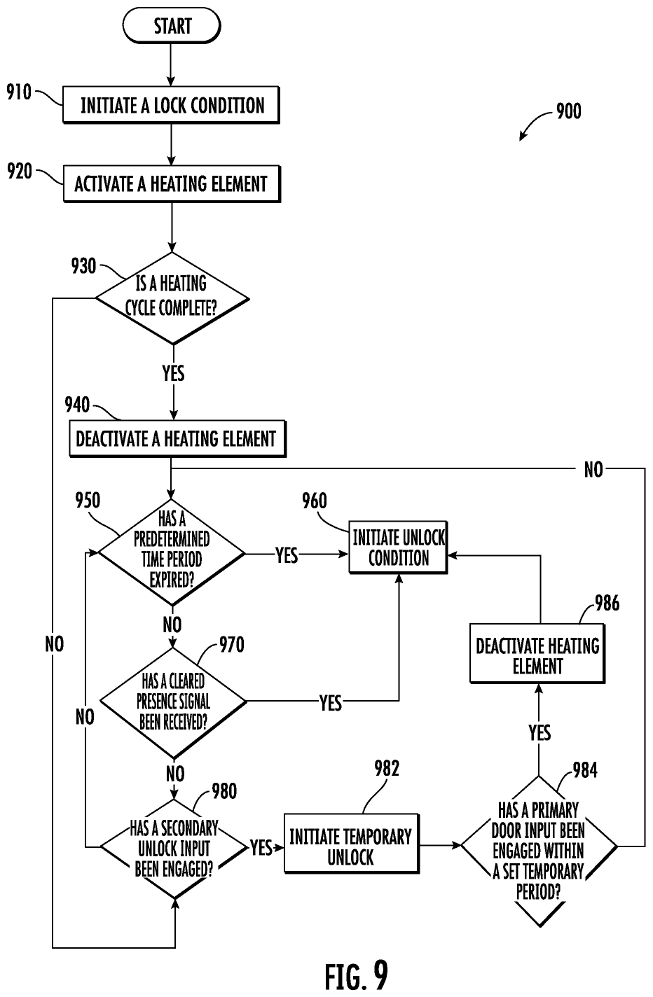

Turning now to FIGS. 8 and 9, the present disclosure may further be directed to algorithms or methods (e.g., method 800 or 900) of operating a microwave oven appliance, such as microwave oven 100. In exemplary embodiments, the controller 140 may be operable to perform various steps of an algorithm or method in accordance with the present disclosure.

The algorithms or methods (e.g., 800 or 900) may occur as, or as part of, a door-monitoring operation of microwave oven 100. In particular, the algorithms or methods (e.g., 800 or 900) disclosed herein may advantageously detect safe conditions and selectively limit the requirement of multi-step opening procedures for opening the door (e.g., while still permitting use of multi-step opening procedures and preventing confusing or unhelpful application of safety related features).

It is noted that the order of steps within algorithms or methods 800 and 900 are for illustrative purposes. Moreover, none of the algorithms or methods 800 and 900 are mutually exclusive. In other words, algorithms or methods within the present disclosure may include one or more of algorithms or methods 800 and 900. All may be adopted or characterized as being fulfilled in a common operation. Except as otherwise indicated, one or more steps in the below algorithms or methods 800 and 900 may be changed, rearranged, performed in a different order, or otherwise modified without deviating from the scope of the present disclosure.

Turning especially to FIG. 8, at 810, the method 800 includes directing a heating cycle. Generally, the heating cycle includes activating a heating element (e.g., magnetron or any additional electrical heating elements, such as a resistive heating element, radiant heating element, induction heating element, etc.). The heating cycle may be based, for instance, on one or more user-set parameters or parameters independently determined by the controller (e.g., based on one or more sensor signals). Such heating cycles and heating element activation are generally understood and may be in accordance with known methods of microwave cooking. It is noted that, in some embodiments, 810 occurs or is initiated prior to one or more other steps of the method 800. For instance, 810 may occur or be initiated prior to 820, 830, 840, or 850.

At 820, the method 800 includes initiating a lock condition in which the chamber door is directed to a lock state (e.g., following or simultaneously to 810). Specifically, the chamber door may be provided in the closed position and the door lock may be provided in the locked state. In some such embodiments, the lock condition or heating cycle may be prompted or initiated (e.g., automatically) in response to a user-selected heating cycle (e.g., 810). Optionally, a heating-time threshold or power-level threshold of the heating cycle may be included, such as a minimum threshold for prompting 820.

The lock condition may be made according to a predetermined time period for which the chamber door is to require multi-step opening procedures. Thus, in general, the predetermined time period may be a period for which multi-step opening procedures (e.g., described above) will be required in order to open the chamber door. The predetermined time period may effectively set the time or moment at which the appliance may be scheduled to switch from the locked condition to an unlocked condition (e.g., without requiring separate steps, instructions, or engagement of the secondary unlock input by the user). The predetermined time period may run or continue after 810 or 830. Optionally, the predetermined time period may be counted from 810 (or another suitable step, such as 830, below). In other words, a timer or tracking program for the predetermined time period may start once (e.g., in response to) the heating cycle is determined to start, predicted to end, determined to end or otherwise expire. In some embodiments, the predetermined time period is a set or fixed value, such as about 30 minutes (e.g., from 830 or the predicted end time of the heating cycle). In alternative embodiments, the predetermined time period is a variable value based on the selected heating cycle (e.g., set according to a predetermined look-up table, formula, chart, or graph).

At 830, the method 800 includes determining expiration of the heating cycle. Such a determination may be based on a predicted or, alternatively, unpredicted criteria. As an example, a predicted criteria may include expiration of a selected cooking time or other parameter of the heating cycle. As an additional or alternative example, an unpredicted criteria may include user-based interruptions to the heating cycle, such as user engagement with one or more inputs (e.g., the primary door input or secondary unlock input). Upon or as part of the determined expiration of the heating cycle, the heating element may be deactivated, as would be understood.

At 840, the method 800 includes determining a cleared-chamber state. Specifically, 840 may be determined prior to expiration of the cleared-chamber state and based, at least in part on received a cleared-chamber signal. Thus, 840 may include receiving a cleared-chamber signal.

In certain embodiments, the cleared-chamber signal is received from the secondary unlock input. In turn, 840 may include receiving an input signal (e.g., corresponding to under engagement) at the secondary unlock input, such as is described above. Optionally, 840 may further require detecting that the door is opened and closed. For instance, subsequent to 820 or 830, 840 may include detecting a door-closing event. Such a detected door-closing event may be based on a signal received from a door sensor (e.g., engaged by or when the chamber door is in the closed position), such as that described above.

In additional or alternative embodiments, the cleared-chamber signal is received from a presence sensor (i.e., PDS). In turn, 840 may include receiving a detection signal from a presence sensor mounted within the cooking chamber. Moreover, the detection signal may correspond to an empty state of the cooking chamber. In particular, it may be determined if one or more signals are received from the presence detection sensor to indicate if one or more food items have been moved from the support pan. If so, the empty or item-absence state indicating a food item has been moved (e.g., removed and is no longer present at the support pan) may be determined.

In some embodiments, determining an empty state includes detecting a reduction in weight (e.g., based on one or more force signals received from the force sensor). The reduction in weight may be, for instance, a reduction in a weight value (e.g., in comparison to a detected weight value prior to 810, 820, or 830) or a switch signal (e.g., indicating a switch is disengaged or not depressed beyond a set threshold, as would otherwise occur in the presence of a food item on the support pan).

In additional or alternative embodiments, determining an empty state is based on one or more received optic signals from the optical sensor. As an example, an image may be captured and analyzed to determine that no food item is detected within the captured image. In other words, an algorithm attempting to recognize one or more items on the support panel may be applied to a captured image. Attempts at recognizing items may be performed by edge matching, divide-and-conquer search, greyscale matching, histograms of receptive field responses, or another suitable routine (e.g., executed at the controller based on one or more captured images from the camera), as would be understood. As an additional or alternative example, one or more signals from the break beam sensor may be received and analyzed to determine that the optical beam is not broken and, thus, no food item is present on the support pan.

At 850, the method 800 includes initiating an unlock condition. Specifically, 850 may be initiated prior to expiration of the cleared-chamber state (e.g., in response to 840). In the unlock condition, the lock condition is halted and the chamber door is held in an unlocked state. Such an unlocked state may eliminate the requirement from multi-step opening procedures (e.g., as would be required as part the lock condition) and, instead permit single-step opening procedures, such as at the primary door input. Thus, a user may open the door by solely engaging the primary door input and without requiring engagement with the secondary unlock input. The unlock condition may continue for an indefinite time period (e.g., irrespective of the predetermined time period), such as until a new heating cycle is initiated. In other words, the predetermined time period (e.g., timing or tracking thereof) may be canceled.

Turning now especially to FIG. 9, at 910, the method 900 includes initiating a lock condition. For instance, 910 may include initiating a lock condition in which the chamber door is held in a locked state. Specifically, the chamber door may be provided in the closed position and the door lock may be provided in the locked state. In some such embodiments, the lock condition or heating cycle may be prompted or initiated (e.g., automatically) in response to a user-selected heating cycle (e.g., input at the control panel).

At 920, the method 900 includes activating a heating element (e.g., magnetron or any additional electrical heating elements, such as a resistive heating element, radiant heating element, induction heating element, etc.), such as part of a heating cycle. Such heating element activation is generally understood and may be in accordance with known methods of microwave cooking.

At 930, the method 900 includes evaluating a heating cycle. Specifically, it may be determined if the heating cycle of 920 is complete. If complete, the method 900 may proceed to 940. If the heating cycle is not complete, though, the method 900 may proceed directly to 980 (e.g., while continuing the heating cycle or activation of the heating element).

At 940, the method 900 includes deactivating the heating element (e.g., such heat is not directly generated by the same), as would be understood. Subsequently, the method 900 may proceed to 950.

At 950, the method 900 includes evaluating a predetermined time period. In general, the predetermined time period may be a period for which multi-step opening procedures (e.g., described above) will be required in order to open the chamber door. The predetermined time period may effectively set the time or moment at which the locked condition may end. Optionally, the predetermined time period may be counted from 940. In other words, a timer or tracking program for the predetermined time period may start once (e.g., in response to) the heating cycle ends or the heating element is deactivated. In some embodiments, the predetermined time period is a set or fixed value, such as about 30 minutes (e.g., from 940). In alternative embodiments, the predetermined time period is a variable value based on the selected heating cycle (e.g., set according to a predetermined look-up table, formula, chart, or graph). If the predetermined time period is complete, the method 900 may proceed to 960. If the heating cycle is not complete, though, the method 900 may proceed to 970.

At 960, the method 900 includes initiating an unlock condition. In the unlock condition, the lock condition is halted and the chamber door is held in an unlocked state. Such an unlocked state may eliminate the requirement from multi-step opening procedures (e.g., as would be required as part the lock condition) and, instead permit single-step opening procedures, such as at the primary door input. Thus, a user may open the door simply by engaging the primary door input and without requiring engagement with the secondary unlock input. The unlock condition may continue for an indefinite time period, such as until a new heating cycle is initiated.

At 970, the method 900 includes evaluating a cleared presence signal received from a presence sensor (i.e., PDS). In particular, it may be determined if one or more signals are received from the presence detection sensor to indicate if one or more food items have been moved from the support pan. Thus, 970 may include either determining an empty or item-absence state indicating a food item has been moved (e.g., removed and is no longer present at the support pan) or, alternatively, determining an occupied state indicating a food item is present (e.g., on the support pan).

In some embodiments, determining an item-absence state includes detecting a reduction in weight (e.g., based on one or more force signals received from the force sensor). The reduction in weight may be, for instance, a reduction in a weight value (e.g., in comparison to a detected weight value prior to 910) or a switch signal (e.g., indicating a switch is disengaged or not depressed beyond a set threshold, as would otherwise occur in the presence of a food item on the support pan).

In additional or alternative embodiments, determining an item-absence state is based on one or more received optic signals from the optical sensor. As an example, an image may be captured and analyzed to determine that no food item is detected within the captured image. In other words, an algorithm attempting to recognize one or more items on the support panel may be applied to a captured image. Attempts at recognizing items may be performed by edge matching, divide-and-conquer search, greyscale matching, histograms of receptive field responses, or another suitable routine (e.g., executed at the controller based on one or more captured images from the camera), as would be understood. As an additional or alternative example, one or more signals from the break beam sensor may be received and analyzed to determine that the optical beam is not broken and, thus, no food item is present on the support pan.

In some embodiments, determining an occupied state includes detecting a maintenance of or increase in weight (e.g., based on one or more force signals received from the force sensor). The maintenance of or increase in weight may be, for instance, a maintenance of or increase in a weight value (e.g., in comparison to a detected weight value prior to 910) or a switch signal (e.g., indicating a switch is engaged or pressed beyond a set threshold corresponding the presence of a food item on the support pan).

In additional or alternative embodiments, determining an occupied state is based on one or more received optic signals from the optical sensor. As an example, an image may be captured and analyzed to determine that one or more food items are detected within the captured image. In other words, an algorithm recognizing one or more items on the support panel may be applied to a captured image. Recognizing items may be performed by edge matching, divide-and-conquer search, greyscale matching, histograms of receptive field responses, or another suitable routine (e.g., executed at the controller based on one or more captured images from the camera), as would be understood. As an additional or alternative example, one or more signals from the break beam sensor may be received and analyzed to determine that the optical beam is broken and, thus, a food item is present on the support pan.

If an item-absence state is determined, the method 900 may proceed to 960. If an occupied state is determined, though, the method 900 may proceed to 980.

At 980, the method 900 includes evaluating the secondary unlock input. Specifically, it may be determined if the first user-engagement action has occurred at the secondary unlock input (e.g., as described above based on a signal—or the absence thereof—from the secondary unlock input). If the secondary unlock input has been engaged, the method 900 may proceed to 982. If the secondary unlock input has not been engaged, though, the method 900 may return to an earlier step, such as 950.

At 982, the method 900 includes unlocking the chamber door temporarily. In other words, the door lock may be moved to the unlocked state, such as for a set temporary time (e.g., between 10 seconds and 1 minute following initiating of 982). Thus, the chamber door may be permitted to open (e.g., in response to user engagement with the primary door input) for the duration of the temporary time.

At 984, the method 900 includes evaluating the primary door input. Specifically, it may be determined if the second user-engagement action has occurred at the primary door input (e.g., as described above based on a signal—or the absence thereof—from the primary door input) within the set temporary time. If the primary door input has been engaged, the method 900 may proceed to 986 for deactivation of the heating element and, then, to 960. If the primary door input has not been engaged, though, the method 900 may return to an earlier step, such as 950.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A microwave oven appliance comprising:
a cabinet defining a cooking chamber;
a magnetron mounted within the cabinet in communication with the cooking chamber to direct a microwave thereto;
a control panel mounted to the cabinet;
a chamber door movably mounted to the cabinet to selectively restrict access to the cooking chamber in a closed position;
a primary door input attached to the cabinet in operable communication with the chamber door to release the chamber door from the closed position;
a secondary unlock input attached to the cabinet to selectively direct the chamber door to an unlocked state; and
a controller in operable communication with the control panel, the controller being configured to direct a door-monitoring operation comprising
initiating a lock condition in which the chamber door is directed to a locked state according to a predetermined time period for which the chamber door is to require multi-step opening procedures,
determining, prior to expiration of the predetermined time period, a cleared-chamber state, determining the cleared-chamber state comprising receiving a cleared-chamber signal, and
initiating, prior to expiration of the predetermined time period and in response to determining the cleared-chamber state, an unlock condition in which the lock condition is halted and the chamber door is held in an unlocked state permitting single-step opening procedures at the primary door input.

2. The microwave oven appliance of claim 1, wherein receiving the cleared-chamber signal comprises receiving an input signal at the secondary unlock input.

3. The microwave oven appliance of claim 2, wherein determining the cleared-chamber state further comprises detecting a door-closing event subsequent to initiating the lock condition.

4. The microwave oven appliance of claim 1, wherein receiving the cleared-chamber signal comprises receiving a detection signal from a presence sensor mounted within the cooking chamber, the detection signal corresponding to an empty state of the cooking chamber.

5. The microwave oven appliance of claim 1, wherein the door-monitoring operation further comprises
directing, prior to the predetermined time period, a heating cycle in which a heating element is directed to an active state to heat one or more items within the cooking chamber.

6. The microwave oven appliance of claim 5, wherein the door-monitoring operation further comprises
determining expiration of the heating cycle,
wherein initiating the lock condition is based on the heating cycle and continues after determining expiration of the heating cycle.

7. The microwave oven appliance of claim 1, wherein the predetermined time period is about 30 minutes.

8. The microwave oven appliance of claim 1, wherein the primary door input comprises a slidable button.

9. The microwave oven appliance of claim 1, wherein the primary door input comprises a pull handle.

10. The microwave oven appliance of claim 1, further comprising:
a door lock in mechanical communication with the chamber door, the door lock being movable between the locked state restricting movement of the chamber door from the closed position and the unlocked state permitting movement of the chamber door from the closed position.

11. A method of operating a microwave oven appliance comprising a cabinet, a control panel, and a chamber door, the method comprising:
initiating a lock condition in which the chamber door is directed to a locked state according to a predetermined time period for which the chamber door is to require multi-step opening procedures;
determining, prior to expiration of the predetermined time period, a cleared-chamber state, determining the cleared-chamber state comprising receiving a cleared-chamber signal; and
initiating, prior to expiration of the predetermined time period and in response to determining the cleared-chamber state, an unlock condition in which the lock condition is halted and the chamber door is held in an unlocked state permitting single-step opening procedures at a primary door input.

12. The method of claim 11, wherein receiving the cleared-chamber signal comprises receiving an input signal at a secondary unlock input.

13. The method of claim 12, wherein determining the cleared-chamber state further comprises detecting a door-closing event subsequent to initiating the lock condition.

14. The method of claim 11, wherein receiving the cleared-chamber signal comprises receiving a detection signal from a presence sensor mounted within a cooking chamber of the microwave oven appliance, the detection signal corresponding to an empty state of the cooking chamber.

15. The method of claim 11, further comprising:
directing, prior to the predetermined time period, a heating cycle in which a heating element is directed to an active state to heat one or more items within a cooking chamber of the microwave oven appliance.

16. The method of claim 15, further comprising:
determining expiration of the heating cycle,
wherein initiating the lock condition is based on the heating cycle and continues after determining expiration of the heating cycle.

17. The method of claim 11, wherein the predetermined time period is about 30 minutes.

18. The method of claim 11, wherein the primary door input comprises a slidable button.

19. The method of claim 11, wherein the primary door input comprises a pull handle.

20. The method of claim 11, wherein the microwave oven appliance further comprises a door lock in mechanical communication with the chamber door, the door lock being movable between the locked state restricting movement of the chamber door from a closed position and the unlocked state permitting movement of the chamber door from the closed position.
